(19) United States
(12) Patent Application Publication
(10) Pub. No.: US 2008/0104298 A1
(43) Pub. Date: May 1, 2008

(54) Expandable Express Card Capable of Isolating Noise and Method for Combining Functionalities of the Express Card with a Non-Host Device

(76) Inventor: Wei-Hung Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/682,285

(22) Filed: Mar. 5, 2007

(30) Foreign Application Priority Data
Nov. 1, 2006 (TW) 095140380

(51) Int. Cl. G06F 13/00

(52) U.S. Cl. 710/301

(57) ABSTRACT

An express card includes a plurality of detection pins, a plurality of power pins, a plurality of Universal Serial Bus (USB) interface pins, a plurality of Peripheral Component Interconnect Express (PCIE) interface pins, a plurality of expandable pins, and a power detection circuit. The power detection circuit includes a plurality of input terminals coupled to the plurality of power pins respectively, a power output terminal for providing the card power, and a control terminal for providing a control signal for enabling or disabling the plurality of expandable pins according to the detection result of the power detection circuit.

### BACKGROUND OF THE INVENTION

1. Field of the Invention

The present invention relates to an express card, and more specifically, to an express card having high adaptability and high expandability.

2. Description of the Prior Art

The specifications of PC cards as drawn up by the PCI-SIG (PCI Special Interest Group) have a long history, and early in 1990, the ISA (Industry Standard Architecture) was used for internal transmission channels. However, traditional bandwidth of the PC card is only 16 MB/s. In 1995, PCI standards were created for the transmission channels used in the 32-bit Card Bus specifications, and are still being followed to this day.

However, the specifications of PC cards are unable to satisfy modern requirements for bandwidth and size, in particular, notebook computers, which have a greater demand for new specifications of PC card. Hence, PCI Express was announced as the official name of the next generation bus structure by the PCMCIA (Personal Computer Memory Card International Association), and simultaneously publicized the specifications of express card. That is to say, the express card is developed to replace the PC card.

A major distinguishing feature of the express card is its high integration of PCI Express and USB 2.0, which differentiates it from the Card Bus based on PCI. If USB 2.0 is used as the transmission channel, then theoretical bandwidth attainable is 480 Mb/s (60 MB/s). However, when changed to PCI Express, then the transmission bandwidth of the express card reaches 500 MB/s, far exceeding that attainable by existing PCI bus specifications. Furthermore, the express card meets market demands because of its smaller size compared to that of the PC card.

However, the applications of the existing express card are not highly adaptable when end users want to extend the functionalities of the express card.

### SUMMARY OF THE INVENTION

The present invention provides an expandable express card comprising a detection pin; a plurality of power pins; a bus; a first interface pin set, coupled to the bus; a controllable inter-connector; a second interface pin set, coupled to the controllable inter-connector; a first functional circuit, coupled to the bus; a second functional circuit, coupled to the controllable inter-connector; and a power detection circuit, comprising a plurality of input terminals coupled to the plurality of power pins, a power output terminal coupled to the first functional circuit, and a control terminal coupled to the controllable inter-connector for enabling or disabling the controllable inter-connector according to the signals detected by the plurality of input terminals; wherein the detection pin is utilized to send an identification signal to a host device when the expandable express card is coupled to the host device and the host device is able to set an operation mode based on the identification signal.

The present invention further provides a noise isolation method for an express card comprising disabling a second interface pin set of the express card when a first interface pin set of the express card is coupled to a host device; and enabling the second interface pin set of the express card when the first interface pin set of the express card is decoupled from the host device.

The present invention further provides a method for combining functionalities of an express card with a non-host device comprising coupling an interface pin set of the express card to the non-host device; the non-host device sending a communication signal to the express card based on a preset communication protocol; and the express card providing corresponding information or performing a functional operation according to the communication signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram schematically illustrating the architecture of an express card according to a first preferred embodiment of the present invention.

FIG. 2 is a functional block diagram schematically illustrating the architecture of an express card according to a second preferred embodiment of the present invention.

FIG. 3 is a functional block diagram schematically illustrating the architecture of an express card according to a third preferred embodiment of the present invention.

FIG. 4 is a flowchart illustrating an expandable method corresponding to the express card shown in FIG. 1 according to the first preferred embodiment of the present invention.

FIG. 5 is a flowchart illustrating an expandable method corresponding to the express card shown in FIG. 2 according to the second preferred embodiment of the present invention.

FIG. 6 is a flowchart illustrating an expandable method corresponding to the express card shown in FIG. 3 according to the third preferred embodiment of the present invention.

FIG. 7 is a flowchart illustrating an expandable method of the express card according to the fourth preferred embodiment of the present invention.

FIG. 8 is a flowchart illustrating an expandable method of the express card according to the fifth preferred embodiment of the present invention.

FIG. 9 is a flowchart illustrating an expandable method of the express card according to the sixth preferred embodiment of the present invention.

### DETAILED DESCRIPTION

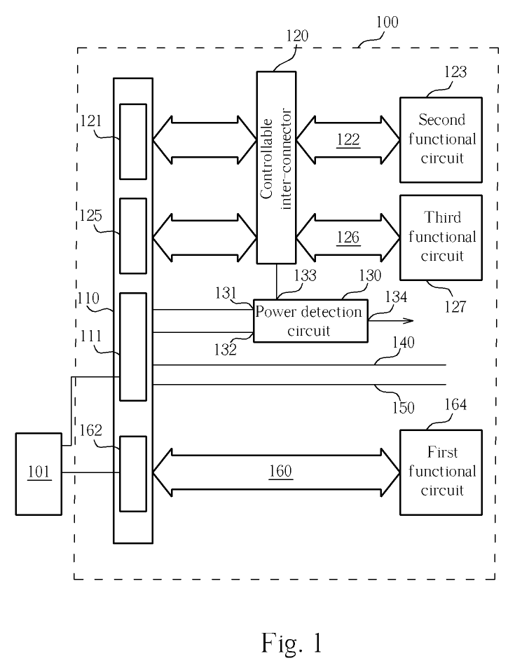

Please refer to FIG. 1. FIG. 1 is a functional block diagram schematically illustrating the architecture of an express card 100 according to a first preferred embodiment of the present invention. The express card 100 comprises an express card I/O connector 110 for providing an interface to a variety of functional applications; a preset interface pin set 111; a first detection pin 140 (the fourth pin of the express card I/O connector 110) coupled to the preset interface pin set 111; a second detection pin 150 (the seventeenth pin of the express card I/O connector 110) coupled to the preset interface pin set 111; a Universal Serial Bus (USB) 160; a first interface pin set 162 coupled to the Universal Serial Bus 160; a first functional circuit 164 coupled to the Universal Serial Bus 160; a controllable inter-connector 120; a second interface pin set 121 coupled to the controllable inter-connector 120; a System Management Bus (SMBus) 122 coupled to the controllable inter-connector 120; a second functional circuit 123 coupled to the System Management Bus 122; a third interface pin set 125 coupled to the controllable inter-connector 120; a Peripheral Component Interconnect Express (PCIE) interface bus 126 coupled to the controllable inter-connector 120; a third functional circuit 127 coupled to the Peripheral Component Interconnect Express interface bus 126; and a power detection circuit 130 coupled to the preset interface pin set 111 of the express card I/O connector 110.

The power detection circuit 130 comprises a first input terminal 131 coupled to a first power pin (the fourteenth pin of the express card I/O connector 110) of the preset interface pin set 111, a second input terminal 132 coupled to a second power pin (the fifteenth pin of the express card I/O connector 110) of the preset interface pin set 111, a power output terminal 134 coupled to the first functional circuit 164, and a control terminal 133 coupled to the controllable inter-connector 120. The control terminal 133 is utilized to provide a control signal to control the controllable inter-connector 120 for enabling or disabling a plurality of expandable pins coupled to the controllable inter-connector 120 according to the detection result of the power detection circuit 130.

The first detection pin 140 or the second detection pin 150 is utilized to send identification signals to a host device 101 when the express card 100 is coupled to the host device 101. Thereafter, the host device 101 is able to adjust an operation mode according to the identification signals.

The first power pin (the 14th pin of the express card I/O connector 110) is utilized to provide a power supply of 3.3 V to the power detection circuit 130 via the first input terminal 131 when the host device 101 receives a low-level identification signal from the first detection pin 140 to enable an operation mode corresponding to the Universal Serial Bus 160. The second power pin (the 15th pin of the express card I/O connector 110) is utilized to provide a power supply of 3.3 V to the power detection circuit 130 via the second input terminal 132 when the host device 101 receives a low-level identification signal from the first detection pin 140 to enable an operation mode corresponding to the Universal Serial Bus 160.

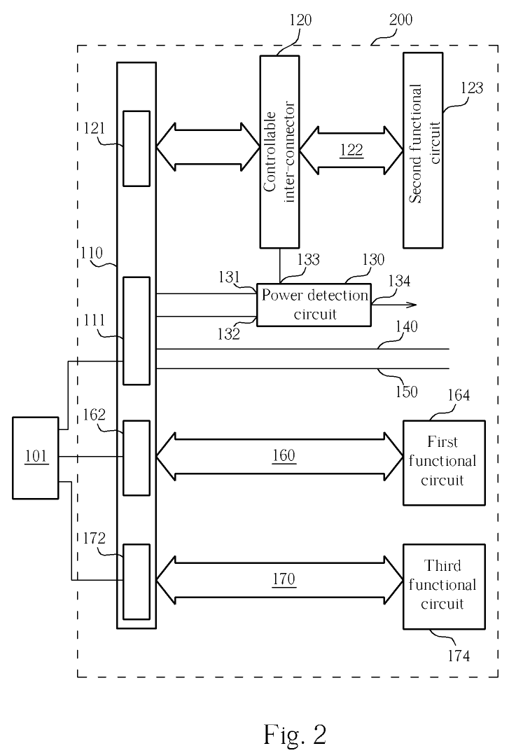

Please refer to FIG. 2. FIG. 2 is a functional block diagram schematically illustrating the architecture of an express card 200 according to a second preferred embodiment of the present invention. The express card 200 comprises an express card I/O connector 110 for providing an interface to a variety of functional applications; a preset interface pin set 111; a first detection pin 140 (the 4th pin of the express card I/O connector 110) coupled to the preset interface pin set 111; a second detection pin 150 (the 17th pin of the express card I/O connector 110) coupled to the preset interface pin set 111; a Universal Serial Bus 160; a first interface pin set 162 coupled to the Universal Serial Bus 160; a first functional circuit 164 coupled to the Universal Serial Bus 160; a controllable inter-connector 120; a second interface pin set 121 coupled to the controllable inter-connector 120; a System Management Bus 122 coupled to the controllable inter-connector 120; a second functional circuit 123 coupled to the System Management Bus 122; a Peripheral Component Interconnect Express interface bus 170; a third interface pin set 172 coupled to the Peripheral Component Interconnect Express interface bus 170; a third functional circuit 174 coupled to the Peripheral Component Interconnect Express interface bus 170; and a power detection circuit 130 coupled to the preset interface pin set 111 of the express card I/O connector 110.

The power detection circuit 130 comprises a first input terminal 131 coupled to a first power pin (the 14th pin of the express card I/O connector 110) of the preset interface pin set 111, a second input terminal 132 coupled to a second power pin (the 15th pin of the express card I/O connector 110) of the preset interface pin set 111, a power output terminal 134 coupled to the first functional circuit 164 and the third functional circuit 174, and a control terminal 133 coupled to the controllable inter-connector 120. The control terminal 133 is utilized to provide a control signal to control the controllable inter-connector 120 for enabling or disabling a plurality of expandable pins coupled to the controllable inter-connector 120 according to the detection result of the power detection circuit 130.

The first detection pin 140 or the second detection pin 150 is utilized to send identification signals to the host device 101 when the express card 100 is coupled to the host device 101. Thereafter, the host device 101 is able to adjust an operation mode according to the identification signals.

The first power pin (the 14th pin of the express card I/O connector 110) is utilized to provide a power supply of 3.3 V to the power detection circuit 130 via the first input terminal 131 when the host device 101 receives a low-level identification signal from the first detection pin 140 and the second detection pin 150 to enable an operation mode corresponding to both the Universal Serial Bus 160 and the Peripheral Component Interconnect Express interface bus 170. The second power pin (the 15th pin of the express card I/O connector 110) is utilized to provide a power supply of 3.3 V to the power detection circuit 130 via the second input terminal 132 when the host device 101 receives a low-level identification signal from the first detection pin 140 and the second detection pin 150 to enable an operation mode corresponding to both the Universal Serial Bus 160 and the Peripheral Component Interconnect Express interface bus 170.

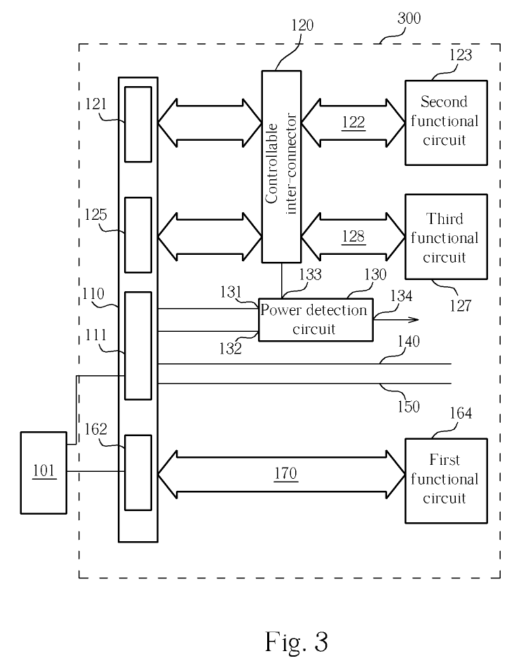

Please refer to FIG. 3. FIG. 3 is a functional block diagram schematically illustrating the architecture of an express card 300 according to a third preferred embodiment of the present invention. The express card 300 comprises an express card I/O connector 110 for providing an interface to a variety of functional applications; a preset interface pin set 111; a first detection pin 140 (the 4th pin of the express card I/O connector 110) coupled to the preset interface pin set 111; a second detection pin 150 (the 17th pin of the express card I/O connector 110) coupled to the preset interface pin set 111; a Peripheral Component Interconnect Express interface bus 170; a first interface pin set 162 coupled to the Peripheral Component Interconnect Express interface bus 170; a first functional circuit 164 coupled to the Peripheral Component Interconnect Express interface bus 170; a controllable inter-connector 120; a second interface pin set 121 coupled to the controllable inter-connector 120; a System Management Bus 122 coupled to the controllable inter-connector 120; a second functional circuit 123 coupled to the System Management Bus 122; a third interface pin set 125 coupled to the controllable inter-connector 120; a Universal Serial Bus 128 coupled to the controllable inter-connector 120; a third functional circuit 127 coupled to the Universal Serial Bus 128; and a power detection circuit 130 coupled to the preset interface pin set 111 of the express card I/O connector 110.

The power detection circuit 130 comprises a first input terminal 131 coupled to a first power pin (the 14th pin of the express card I/O connector 110) of the preset interface pin set 111, a second input terminal 132 coupled to a second power pin (the 15th pin of the express card I/O connector 110) of the preset interface pin set 111, a power output terminal 134 coupled to the first functional circuit 164, and a control terminal 133 coupled to the controllable inter-connector 120. The control terminal 133 is utilized to provide a control signal to control the controllable inter-connector 120 for enabling or disabling a plurality of expandable pins coupled to the controllable inter-connector 120 according to the detection result of the power detection circuit 130.

The first detection pin 140 or the second detection pin 150 is utilized to send identification signals to the host device 101 when the express card 100 is coupled to the host device 101. Thereafter, the host device 101 is able to adjust an operation mode according to the identification signals.

The first power pin (the 14th pin of the express card I/O connector 110) is utilized to provide a power supply of 3.3 V to the power detection circuit 130 via the first input terminal 131 when the host device 101 receives a low-level identification signal from the second detection pin 150 to enable an operation mode corresponding to the Peripheral Component Interconnect Express interface bus 170. The second power pin (the 15th pin of the express card I/O connector 110) is utilized to provide a power supply of 3.3 V to the power detection circuit 130 via the second input terminal 132 when the host device 101 receives a low-level identification signal from the second detection pin 150 to enable an operation mode corresponding to the Peripheral Component Interconnect Express interface bus 170.

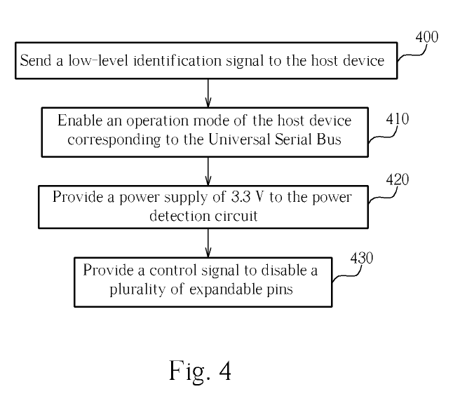

Please refer to FIG. 4 in conjunction with FIG. 1. FIG. 4 is a flowchart illustrating an expandable method corresponding to the express card 100 shown in FIG. 1 according to the first preferred embodiment of the present invention. When the express card 100 is coupled to the host device 101, the expandable method comprises the following steps:

Step 400: The express card 100 sends a low-level identification signal to the host device 101 via the first detection pin 140;

Step 410: The host device 101 enables an operation mode corresponding to the Universal Serial Bus 160 when the host device 101 detects the low-level identification signal;

Step 420: The host device 101 provides a power supply of 3.3 V to the power detection circuit 130 via the first input terminal 131 or the second input terminal 132; and

Step 430: The power detection circuit 130 provides a control signal via the control terminal 133 to disable a plurality of expandable pins coupled to the controllable inter-connector 120 when the power detection circuit 130 detects the power supply of 3.3 V via the first input terminal 131 or the second input terminal 132 furnished by the host device 101, and provides a power supply of 3.3 V via the power output terminal 134 to the first functional circuit 164.

In the first preferred embodiment of the expandable method, the low-level identification signal may be a ground signal, and the plurality of expandable pins coupled to the controllable inter-connector 120 may comprise the connecting pins of the express card I/O connector 110 excluding the connecting pins 1, 2, 3, 4, 14, and 15. The second detection pin 150 (the 17th pin of the express card I/O connector 110) may either be used as a detection pin for sending a low-level identification signal to the host device 101 by the express card 100 or be an expandable pin coupled to the controllable inter-connector 120.

When the express card 100 is decoupled from the host device 101, the expandable method comprises the following steps: the host device 101 ceases to provide the power supply of 3.3 V to the power detection circuit 130 via the first input terminal 131 or the second input terminal 132 which in turn ceases to provide the power supply of 3.3 V via the power output terminal 134 to the first functional circuit 164; and the power detection circuit 130 provides a control signal via the control terminal 133 to enable the plurality of expandable pins coupled to the controllable inter-connector 120 when the power detection circuit 130 detects no power supply of 3.3 V via the first input terminal 131 or the second input terminal 132 furnished by the host device 101.

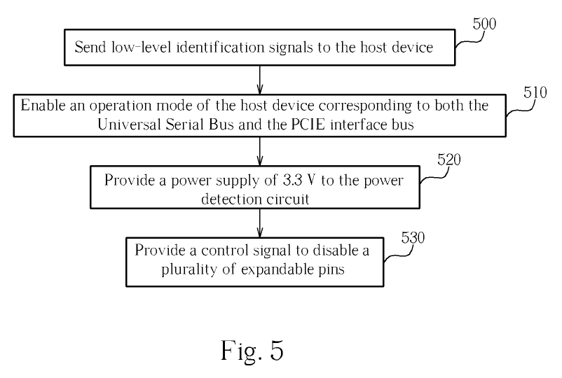

Please refer to FIG. 5 in conjunction with FIG. 2. FIG. 5 is a flowchart illustrating an expandable method corresponding to the express card 200 shown in FIG. 2 according to the second preferred embodiment of the present invention. When the express card 200 is coupled to the host device 101, the expandable method comprises the following steps:

Step 500: The express card 200 sends low-level identification signals to the host device 101 via the first detection pin 140 and the second detection pin 150;

Step 510: The host device 101 enables an operation mode corresponding to both the Universal Serial Bus 160 and the Peripheral Component Interconnect Express interface bus 170 when the host device 101 detects the low-level identification signals;

Step 520: The host device 101 provides a power supply of 3.3 V to the power detection circuit 130 via the first input terminal 131 or the second input terminal 132; and

Step 530: The power detection circuit 130 provides a control signal via the control terminal 133 to disable a plurality of expandable pins coupled to the controllable inter-connector 120 when the power detection circuit 130 detects the power supply of 3.3 V via the first input terminal 131 or the second input terminal 132 furnished by the host device 101, and provides a power supply of 3.3 V via the power output terminal 134 to the first functional circuit 164 and the third functional circuit 174.

In the second preferred embodiment of the expandable method, the low-level identification signals may be ground signals, and the plurality of expandable pins coupled to the controllable inter-connector 120 may comprise the connecting pins of the express card I/O connector 110 excluding the connecting pins 1, 2, 3, 4, 13, 14, 15, 17, 18, 19, 21, 22, 24, and 25.

When the express card 200 is decoupled from the host device 101, the expandable method comprises the following steps: the host device 101 ceases to provide the power supply of 3.3 V to the power detection circuit 130 via the first input terminal 131 or the second input terminal 132 which in turn ceases to provide the power supply of 3.3 V via the power output terminal 134 to the first functional circuit 164 and the third functional circuit 174; and the power detection circuit 130 provides a control signal via the control terminal 133 to enable the plurality of expandable pins coupled to the controllable inter-connector 120 when the power detection circuit 130 detects no power supply of 3.3 V via the first input terminal 131 or the second input terminal 132 furnished by the host device 101.

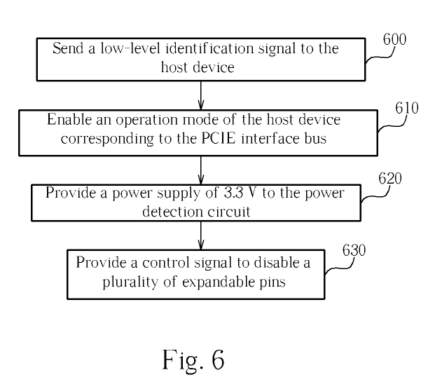

Please refer to FIG. 6 in conjunction with FIG. 3. FIG. 6 is a flowchart illustrating an expandable method corresponding to the express card 300 shown in FIG. 3 according to the third preferred embodiment of the present invention. When the express card 300 is coupled to the host device 101, the expandable method comprises the following steps:

Step 600: The express card 300 sends a low-level identification signal to the host device 101 via the second detection pin 150;

Step 610: The host device 101 enables an operation mode corresponding to the Peripheral Component Interconnect Express interface bus 170 when the host device 101 detects the low-level identification signal;

Step 620: The host device 101 provides a power supply of 3.3 V to the power detection circuit 130 via the first input terminal 131 or the second input terminal 132; and

Step 630: The power detection circuit 130 provides a control signal via the control terminal 133 to disable a plurality of expandable pins coupled to the controllable inter-connector 120 when the power detection circuit 130 detects the power supply of 3.3 V via the first input terminal 131 or the second input terminal 132 furnished by the host device 101, and provides a power supply of 3.3 V via the power output terminal 134 to the first functional circuit 164.

In the third preferred embodiment of the expandable method, the low-level identification signal may be a ground signal, and the plurality of expandable pins coupled to the controllable inter-connector 120 may comprise the connecting pins of the express card I/O connector 110 excluding the connecting pins 13, 14, 15, 17, 18, 19, 21, 22, 24, and

25. The first detection pin 140 (the 4th pin of the express card I/O connector 110) may either be used as a detection pin for sending a low-level identification signal to the host device 101 by the express card 300 or be an expandable pin coupled to the controllable inter-connector 120.

When the express card 300 is decoupled from the host device 101, the expandable method comprises the following steps: the host device 101 ceases to provide the power supply of 3.3 V to the power detection circuit 130 via the first input terminal 131 or the second input terminal 132 which in turn ceases to provide the power supply of 3.3 V via the power output terminal 134 to the first functional circuit 164; and the power detection circuit 130 provides a control signal via the control terminal 133 to enable the plurality of expandable pins coupled to the controllable inter-connector 120 when the power detection circuit 130 detects no power supply of 3.3 V via the first input terminal 131 or the second input terminal 132 furnished by the host device 101.

When the express card of the present invention is coupled to a non-host device, the expandable method comprises the following steps: the non-host device sends a communication signal to the express card based on a preset communication protocol; and the express card provides corresponding information to the non-host device or performs a functional operation in response to the communication signal.

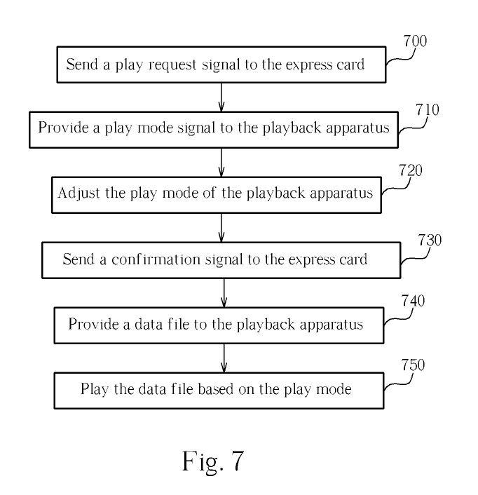

Please refer to FIG. 7. FIG. 7 is a flowchart illustrating an expandable method of the express card according to the fourth preferred embodiment of the present invention. The express card may be the express card 100 shown in FIG. 1, the express card 200 shown in FIG. 2, or the express card 300 shown in FIG. 3. When the express card is coupled to a playback apparatus, the expandable method comprises the following steps:

Step 700: The playback apparatus sends a play request signal to the express card based on a preset communication protocol;

Step 710: The express card provides a play mode signal to the playback apparatus in response to the play request signal;

Step 720: The playback apparatus adjusts the play mode according to the received play mode signal;

Step 730: The playback apparatus sends a confirmation signal to the express card when the play mode is adjusted;

Step 740: The express card provides a data file to the playback apparatus in response to the confirmation signal; and

Step 750: The playback apparatus plays the received data file based on the play mode.

In the fourth preferred embodiment of the present invention, the data file to be played may be a video file, a music file, or a multimedia file, etc. The play mode may be utilized to adjust a video setting or a sound effect setting. The video setting may comprise a wide screen setting, a pan & scan setting, a color adjustment setting, or a subtitle setting, etc. The sound effect setting may comprise a stereo setting, a Dolby digital setting, an audio language setting, a soundtrack setting, or an equalizer setting, etc. In another embodiment, step 740 and step 750 may be altered so that the express card may transmit a stream of data packets instead of a data file to the playback apparatus while processing the playing based on a streaming transmission.

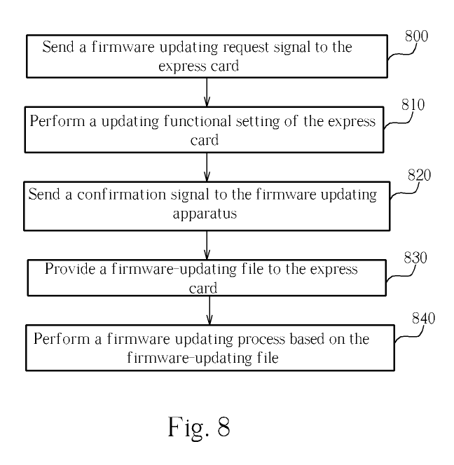

Please refer to FIG. 8. FIG. 8 is a flowchart illustrating an expandable method of the express card according to the fifth preferred embodiment of the present invention. The express card may be the express card 100 shown in FIG. 1, the express card 200 shown in FIG. 2, or the express card 300 shown in FIG. 3. When the express card is coupled to a firmware updating apparatus, the expandable method comprises the following steps:

Step 800: The firmware updating apparatus sends a firmware updating request signal to the express card based on a preset communication protocol;

Step 810: The express card performs an updating functional setting in response to the firmware updating request signal provided by the firmware updating apparatus;

Step 820: The express card sends a confirmation signal to the firmware updating apparatus when the updating functional setting is finished;

Step 830: The firmware updating apparatus provides a firmware-updating file to the express card in response to the confirmation signal; and

Step 840: The express card performs a firmware updating process based on the received firmware-updating file.

In the fifth preferred embodiment of the present invention, the firmware update process may be utilized to debug the firmware stored in the express card. In another embodiment, step 830 and step 840 may be altered so that the firmware updating apparatus may transmit a stream of firmware-updating data packets instead of a firmware-updating file to the express card while processing the firmware updating based on a streaming transmission.

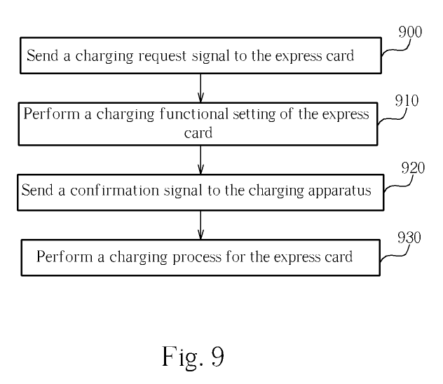

Please refer to FIG. 9. FIG. 9 is a flowchart illustrating an expandable method of the express card according to the sixth preferred embodiment of the present invention. The express card may be the express card 100 shown in FIG. 1, the express card 200 shown in FIG. 2, or the express card 300 shown in FIG. 3. When the express card is coupled to a charging apparatus, the expandable method comprises the following steps:

Step 900: The charging apparatus sends a charging request signal to the express card based on a preset communication protocol;

Step 910: The express card performs a charging functional setting in response to the charging request signal provided by the charging apparatus;

Step 920: The express card sends a confirmation signal to the charging apparatus when the charging functional setting is finished; and

Step 930: The express card performs a charging process with the aid of the charging apparatus in response to the confirmation signal.

In the sixth preferred embodiment of the present invention, the charging functional setting may be utilized to set a charging voltage or a charging current so that the express card is able to avoid damage from unacceptable charging voltage or charging current.

Based on the plurality of the preferred embodiments according to the present invention, the express card of the present invention is able to expand functionalities not limited to the existing specifications of the express card. The express card of the present invention may be designed based on the Universal Serial Bus, on the Peripheral Component Interconnect Express interface bus, or on both the Universal Serial Bus and the Peripheral Component Interconnect Express interface bus. In summary, the express card of the present invention is highly adaptable when end users want to extend the functionalities of the express card.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An expandable express card comprising:
a detection pin;
a plurality of power pins;
a bus;
a first interface pin set, coupled to the bus;
a controllable inter-connector;
a second interface pin set, coupled to the controllable inter-connector;
a first functional circuit, coupled to the bus;
a second functional circuit, coupled to the controllable inter-connector; and
a power detection circuit, comprising a plurality of input terminals coupled to the plurality of power pins, a power output terminal coupled to the first functional circuit, and a control terminal coupled to the controllable inter-connector for enabling or disabling the controllable inter-connector according to the signals detected by the plurality of input terminals;
wherein the detection pin is utilized to send an identification signal to a host device when the expandable express card is coupled to the host device and the host device is able to perform an operational setting based on the identification signal.

2. The expandable express card of claim 1, wherein the bus is a Universal Serial Bus.

3. The expandable express card of claim 2, further comprising:
a Peripheral Component Interconnect Express interface bus;
a third interface pin set, coupled to the Peripheral Component Interconnect Express interface bus; and
a third functional circuit, coupled to the Peripheral Component Interconnect Express interface bus;
wherein the power output terminal of the power detection circuit is also coupled to the third functional circuit.

4. The expandable express card of claim 2, further comprising:
a Peripheral Component Interconnect Express interface bus, coupled to the controllable inter-connector;
a third interface pin set, coupled to the controllable inter-connector; and
a third functional circuit, coupled to the Peripheral Component Interconnect Express interface bus.

5. The expandable express card of claim 1, further comprising:
a System Management Bus, coupled between the controllable inter-connector and the second functional circuit.

6. The expandable express card of claim 1, wherein the bus is a Peripheral Component Interconnect Express interface bus.

7. The expandable express card of claim 6, further comprising:
a Universal Serial Bus, coupled to the controllable inter-connector;
a third interface pin set, coupled to the controllable inter-connector; and
a third functional circuit, coupled to the Universal Serial Bus.

8. A noise isolation method for an express card, comprising:
disabling a second interface pin set of the express card when a first interface pin set of the express card is coupled to a host device.

9. The noise isolation method of claim 8, wherein disabling a second interface pin set of the express card when a first interface pin set of the express card is coupled to a host device comprises disabling a second interface pin set of the express card when a first interface pin set of the express card is coupled to a computer.

10. The noise isolation method of claim 8, further comprising:
attaching the first interface pin set of the express card into an express card port of the host device.

11. The noise isolation method of claim 8, further comprising:
enabling the second interface pin set of the express card when the first interface pin set of the express card is decoupled from the host device.

12. The noise isolation method of claim 11, further comprising:
decoupling the second interface pin set of the express card from the host device.

13. A method for combining functionalities of an express card with a non-host device, comprising:
coupling an interface pin set of the express card to the non-host device;
the non-host device sending a communication signal to the express card based on a preset communication protocol; and
the express card providing corresponding information or performing a functional operation in response to the communication signal.

14. The method of claim 13, wherein
coupling an interface pin set of the express card to the non-host device comprises attaching an interface pin set of the express card to a playback apparatus;
the non-host device sending a communication signal to the express card based on a preset communication protocol comprises the playback apparatus sending a play request signal to the express card based on a preset communication protocol;
the express card providing corresponding information or performing a functional operation in response to the communication signal comprises:
the express card providing a play mode signal to the playback apparatus in response to the play request signal;
the playback apparatus adjusting the play mode according to the received play mode signal;
the playback apparatus sending a confirmation signal to the express card when the play mode is adjusted;
the express card providing a data file to the playback apparatus in response to the confirmation signal; and
the playback apparatus playing the received data file based on the play mode.

15. The method of claim 14, wherein the playback apparatus adjusting the play mode according to the received play mode signal comprises the playback apparatus adjusting a video setting or a sound effect setting according to the received play mode signal.

16. The method of claim 13, wherein
coupling an interface pin set of the express card to the non-host device comprises attaching an interface pin set of the express card to a firmware updating apparatus;
the non-host device sending a communication signal to the express card based on a preset communication protocol comprises the firmware updating apparatus sending a firmware updating request signal to the express card based on a preset communication protocol;
the express card providing corresponding information or performing a functional operation in response to the communication signal comprises:
the express card performing an updating functional setting in response to the firmware updating request signal provided by the firmware updating apparatus;
the express card sending a confirmation signal to the firmware updating apparatus when the updating functional setting is finished;
the firmware updating apparatus providing a firmware-updating file to the express card in response to the confirmation signal; and
the express card performing a firmware updating process based on the received firmware-updating file.

17. The method of claim 16, wherein the express card performing an updating functional setting in response to the firmware updating request signal provided by the firmware updating apparatus comprises the express card performing a firmware debugging setting in response to the firmware updating request signal provided by the firmware updating apparatus.

18. The method of claim 13, wherein
coupling an interface pin set of the express card to the non-host device comprises attaching an interface pin set of the express card to a charging apparatus;
the non-host device sending a communication signal to the express card based on a preset communication protocol comprises the charging apparatus sending a charging request signal to the express card based on a preset communication protocol;
the express card providing corresponding information or performing a functional operation in response to the communication signal comprises:
the express card performing a charging functional setting in response to the charging request signal provided by the charging apparatus;
the express card sending a confirmation signal to the charging apparatus when the charging functional setting is finished; and
the express card performing a charging process with the aid of the charging apparatus in response to the confirmation signal.

19. The method of claim 18, wherein the express card performing a charging functional setting in response to the charging request signal provided by the charging apparatus comprises the express card performing a charging voltage setting or a charging current setting in response to the charging request signal provided by the charging apparatus.
